(19) United States
(12) Patent Application Publication
(10) Pub. No.: US 2023/0376977 A1
(43) Pub. Date: Nov. 23, 2023

(54) SYSTEM FOR DETERMINING CROSS SELLING POTENTIAL OF EXISTING CUSTOMERS

(71) Applicant: Valdimir Pte. Ltd., Singapore (SG)

(72) Inventors: Yu Hui Yao, Singapore (SG); Xu Cheng, Singapore (SG)

(73) Assignee: Valdimir Pte. Ltd., Singapore (SG)

(21) Appl. No.: 17/854,076

(22) Filed: Jun. 30, 2022

(30) Foreign Application Priority Data
May 19, 2022 (HK) 32022053757.7

(51) Int. Cl. G06Q 30/02; G06Q 40/08; G06N 20/20

(52) U.S. Cl. CPC G06Q 30/0202; G06Q 40/08; G06N 20/20

(57) ABSTRACT

A computer implemented method, system and non-transitory medium for predicting whether a new customer of one or more insurance products will purchase an additional insurance product. Training data associated with a set of customers is collected, and a dataset generated containing customers who have made two or more insurance purchases. Data fields are extracted using a sequential marked basket analysis algorithm and multiple augmented training data sets using different encoding techniques generated therefrom. Data fields are extracted from each augmented data set using a feature extraction algorithm. A plurality of models are trained on the extracted data fields and values with the performance of each trained model on a combination of the augmented data sets evaluated. The output of each trained model is weighted according to the determined model performance and used to predict the likelihood of a new customer to purchase an additional insurance product.

### FIELD OF THE DISCLOSURE

The present disclosure relates to a system for assessing potential for purchase by an existing customer of additional product(s), especially insurance or financial products.

### BACKGROUND OF THE DISCLOSURE

A customer purchasing an insurance or financial product from a company often enters into a long term relationship with that company; initially driven by that customer's need for a specific finance or insurance product. Such customers typically provide the company with a wealth of demographic, transactional and behavioural information over the course of their business relationship with that company. After the initial purchase of a product, the same customers may have an interest/need for additional product(s) which could be provided by the company; thereby strengthening the relationship between the customer and the company and preventing them from sourcing the same/additional products from competitors. As the customer acquires more products and services from the same company this maximises the potential lifetime customer value of that specific customer.

Various approaches have been devised to try to determine which customers have the highest potential for acquiring additional products from a company, at what time, and which additional product(s) based upon the analysis of various factors after an initial purchase of a product.

Despite the use of various approaches to attempt to identify potential customers with the highest propensity for making a subsequent purchase from a company of another product, there has been limited success. Such approaches include statistical approaches using regression analysis or the like, which provide limited insights in view of over optimistic inflated results on typically imbalanced datasets.

Attempts have been made to use machine learning to identify from a pool of existing customers which customers are most likely to acquire additional product(s) and which product(s) might be appropriate at what time. However, in view of typically small data sets, low transaction frequency skewing data, and/or absence or limited feature engineering typically compromised or unreliable models developed which has meant many Al solutions are ineffective. Furthermore, many of the models developed do not include many factors which actually affect the customer's willingness to purchase additional products.

It would be appreciated that the use of defective models compromise the efficiency of the analysis process and/or potentially providing limited predictive value. The development of poor models has in turn lead to increased processing time required in analysing large volumes of data, and unreliable and inappropriate customer or product selection including inappropriate identification of potential customers, appropriate products and/or timing. It would be appreciated that identification of inappropriate customers for cross selling with additional products could actually even drive an existing customer away from the company to a competitor.

Accordingly, there exists a need for a process/system which addresses or at least ameliorates the above deficiencies of these approaches.

### SUMMARY OF THE DISCLOSURE

Features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims.

In accordance with a first aspect of the present disclosure, there is provided a computer implemented method comprising
collecting data associated with a set of customers, and generating a dataset therefrom containing data for customers having made two or more insurance purchases from one or more entities in a company group; said data including at least product type purchased, representative insurance agent information and timing of purchase;
extracting from the dataset a first plurality of data fields using a sequential market basket analysis algorithm
generating a plurality of augmented training data sets using a plurality of different encoding techniques from said extracted first plurality of data fields;
extracting using an automatic feature extraction algorithm with a customised migration time window values for a second plurality of data fields from said plurality of augmented training data sets;
training in parallel a plurality of models on said second plurality of extracted data fields and evaluating the performance of each trained model thereupon;
weighting each trained model according to the determined model performance to provide an ensemble of trained models;
generating by said ensemble of trained models, a prediction of a propensity of a new customer of one or more products to purchase an additional product in a subsequent transaction upon receiving at least some values for said new customer including an initial product type purchased, customer status information, representative insurance agent information and timing of purchase.

Preferably, the customer status information comprises one or more values selected from the group comprising gender, marital status, location information, job level, age and policy account.

Advantageously, the performance of each trained model on the second plurality of extracted data fields from said plurality of augmented data sets may be evaluated using a Matthews Correlation Coefficient.

The plurality of different encoding techniques may be selected from the group comprising one hot encoding, outlier elimination, data scaling and rebalancing by oversampling minority class of cross sell product occurrence and undersampling the majority class of non-cross sell product. Undersampling the majority class of non-cross sell product may be performed using the synthetic minority oversampling technique (SMOTE).

Advantageously undersampling was processed using the synthetic minority oversampling technique (SMOTE) to synthesize new examples for a minority class of cross sell occurrence such that the number of occurrences in the majority class of no cross sell occurrence had less than half the total of the sum of the number of occurrences in the majority class added to the number of occurrences in the minority class.

Preferably the second plurality of data fields extracted from each augmented data set include a plurality of fields characterising the relationship between the customer and the insurance agent.

The second plurality of data fields extracted from each augmented data set may be selected from the group comprising cross selling score of the specified agent, product selling experience for the specified product, tenure of agent, agent activity and an indication of whether the agent has sold multiple product categories.

The sequential market based analysis pattern extraction may be performed using the Sequential Pattern Discovery using Equivalence classes (SPADE) algorithm.

The automated feature extraction may be performed using deep feature synthesis to build predictive data sets by stacking data primitives.

The overall weighting of each model in the prediction may be determined by multiplying the Matthews Correlation Coefficient for each model by the output of that model.

The plurality of models may comprise gradient boosting model selected from a group comprising XGBoost, Catboost and LightGBM.

The plurality of models may be trained in parallel using sequential model based global optimisation for automatic hyper parameter learning.

Advantageously, the predicted timing for said subsequent transaction for the new customer is provided by the ensemble of optimised models.

In a second aspect there is provided a computer system for predicting the potential for cross selling an insurance product to a customer who has purchased an insurance product; the system comprising:
an ensemble of trained models which make a prediction of a propensity of a new customer of one or more products to purchase an additional product in a subsequent transaction upon receiving at least some values for said customer including an initial product type purchased, customer status information, representative insurance agent information and timing of purchase;
wherein said training of the ensemble of models is performed by a plurality of modules comprising:
   a data collection module for receiving and storing a set of training data associated with a set of customers, and generating a dataset therefrom containing data for customers who have made two or more purchases from one or more entities in a company group; said data including at least product type purchased, representative insurance agent information and timing of purchase;
   a first extraction module for extracting a first plurality of data fields using a sequential marked basket analysis algorithm from the dataset;
   an augmentation module for generating a plurality of augmented training data sets using a plurality of different encoding techniques from the first plurality of data fields;
   a second extraction module for extracting from each augmented dataset of training data a second plurality of data fields using an automatic feature extraction algorithm with a customised migration time window;
   a model optimisation module for training in parallel a plurality of models on the second plurality of extracted data fields and evaluating the performance of each trained model; and weighting each trained model according to the determined model performance to provide said ensemble of trained models.

Advantageously, the customer status information comprises one or more values selected from the group comprising gender, marital status, location information, job level, age and policy account.

The evaluation of the performance of each trained model on the second plurality of extracted data fields from said plurality of augmented data sets may be performed using a Matthews Correlation Coefficient.

The augmentation module may be configured to apply a plurality of different encoding techniques to the training data set, wherein said encoding techniques are selected from the group comprising one hot encoding, outlier elimination, data scaling and rebalancing by oversampling minority class of cross sell product occurrence and under sampling the majority class of non-cross sell product.

The under sampling of the majority class of non-cross sell product may be performed by using the synthetic minority oversampling technique (SMOTE).

Under sampling may be processed using the synthetic minority oversampling technique (SMOTE) to synthesize new examples for a minority class of cross sell occurrence such that the number of occurrences in the majority class of no cross sell occurrence had less than half the total of the sum of the number of occurrences in the majority class added to the number of occurrences in the minority class.

The first plurality of data fields extracted from each augmented data set may include a plurality of fields characterising the relationship between the new customer and the insurance agent.

The plurality of data fields extracted from each augmented data set may be selected from the group comprising cross selling score of the specified agent, product selling experience for the specified product, tenure of agent, agent activity and an indication of whether the agent has sold multiple product categories.

The sequential market based analysis pattern extraction may be performed using the Sequential Pattern Discovery using Equivalence classes (SPADE) algorithm.

The automated feature extraction may be performed using deep feature synthesis to build predictive data sets by stacking data primitives.

The overall weighting of each model in the model optimisation module in determining the prediction may be determined by multiplying the Matthews Correlation Coefficient for each model by the output of that model.

The plurality of models in the model optimisation module may comprise gradient boosting models, selected from a group comprising XGBoost, Catboost and LightGBM.

The plurality of models in the model optimisation module may be trained in parallel using sequential model based global optimisation for automatic hyper parameter learning.

The new customer predicted timing for said subsequent transaction may also be provided by the ensemble of optimised models.

In a further aspect there is provided a non-transitory computer readable storage medium having computer readable instructions recorded therein to predict a propensity of a new customer of one or more insurance products to purchase an additional product in a subsequent transaction, the instructions when executed on a processor cause that processor to implement a method comprising:
collecting data associated with a set of customers, and generating a dataset therefrom containing data for customers having made two or more insurance purchases from one or more entities in a company group; said data including at least product type purchased, representative insurance agent information and timing of purchase;
extracting from the dataset a first plurality of data fields using a sequential marked basket analysis algorithm
generating a plurality of augmented training data sets using a plurality of different encoding techniques from said extracted first plurality of data fields;
extracting using an automatic feature extraction algorithm with a customised migration time window a second plurality of data fields from said plurality of augmented training data sets;
training in parallel a plurality of models on the second plurality of extracted data fields and evaluating the performance of each trained model thereupon;
weighting each trained model according to the determined model performance to provide an ensemble of trained models;
generating by said ensemble of trained models, a prediction of a propensity of a new customer of one or more products to purchase an additional product in a subsequent transaction upon receiving at least some values for said new customer including an initial product type purchased, customer status information, representative insurance agent information and timing of purchase.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended Figures. Understanding that these Figures depict only exemplary embodiments of the disclosure and are not therefore to be considered to be limiting of its scope, the principles herein are described and explained with additional specificity and detail through the use of the accompanying Figures.

Preferred embodiments of the present disclosure will be explained in further detail below by way of examples and with reference to the accompanying Figures, in which:

FIG. 1 depicts a schematic representation of exemplary steps performed in an embodiment of the present disclosure.

FIG. 2A depicts a representation of one hot encoding data transformation data augmentation technique; one of the techniques used in the data augmentation step of the present disclosure.

FIG. 2B depicts an exemplary representation of outlier elimination data augmentation technique; one of the techniques used in the data augmentation step of the present disclosure.

FIG. 2C depicts an exemplary representation of robust standardisation/robust data scaling; one of the techniques used in the data augmentation step of the present disclosure.

FIG. 2D depicts an exemplary representation of rebalancing of the dataset; one of the techniques used in the data augmentation step of the present disclosure.

FIG. 3 is an exemplary representation of a visualisation made by the SPADE algorithm during the feature extraction process on a training data set.

FIG. 4 is an exemplary schematic representation of an embodiment of a computer system in which the processes discussed herein are performed.

### DETAILED DESCRIPTION OF THE PREFERRED EMBODIMENTS

Various embodiments of the disclosure are discussed in detail below. While specific implementations are discussed, it should be understood that this is done for illustration purposes only. A person skilled in the relevant art will recognize that other components and configurations may be used without departing from the spirit and scope of the disclosure.

The disclosed technology addresses the need in the art for an accurate, efficient and computationally less intensive way to identify from a customer dataset the most likely prospects which are likely to purchase one or more subsequent products from a company, especially an insurance or finance company.

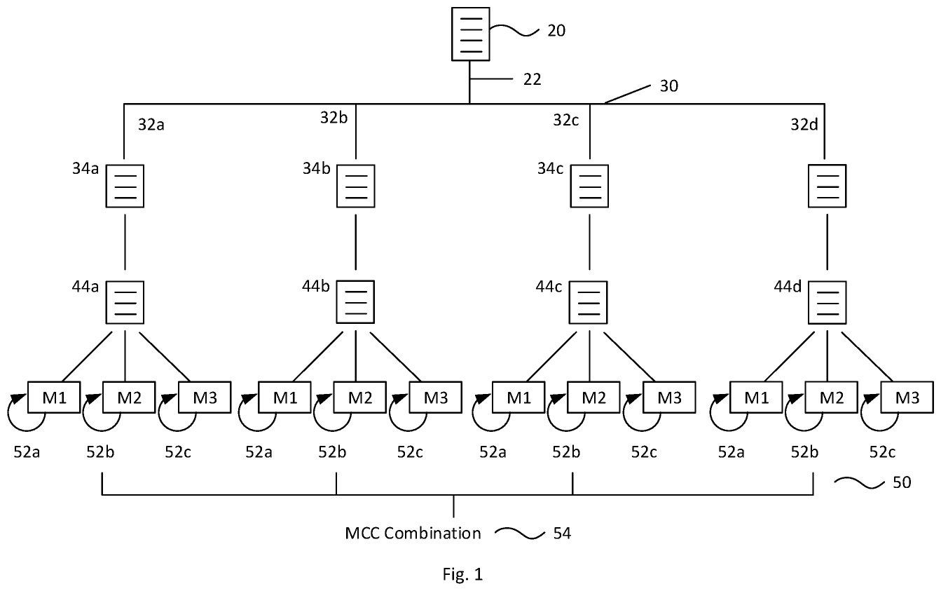

As depicted in FIG. 1, the exemplary steps of the computer implemented method 10 are outlined in overview before being discussed in more detail.

As depicted at Step 20, an original dataset of at least 1,000 customers who had at least two and potentially more purchases from one or more entities in a company group via a sales agent including at least product type, sales agent information and timing of purchase was obtained. It would be appreciated that the number of customers in the original set could be 2,000, or 3,000 or more, without departing from the scope of the present method; and also that an increased number of customer records would provide additional insights.

An example data record for four subjects is set out below.

| | | | | | |
|---|---|---|---|---|---|
| gender | Male | Female | Female | Female | Female |
| marital status | Married | Divorced | Married | Married | Married |
| province | Kanchanaburi | Bangkok | Nonthaburi | Nakhon | Bangkok |
| | | | | Nayok | |
| customer_job_class | 1 level of risk | 2 level | 2 level of | 1 level of | 1 level of |
| | | of risk | risk | risk | risk |
| age | 45 | 59 | 53 | 65 | 40 |
| agebin | 40-45 | 55-60 | 50-55 | 60-65 | 35-40 |
| claim_approved_tag | 1 | 1 | 1 | 1 | 1 |
| policy | 3 | 3 | 5 | 2 | 1 |
| category | 4 | 3 | 8 | 1 | 3 |
| premium | 80744 | 1567183 | 1671721 | 502630 | 33333 |
| tenure | 12 | 4 | 0 | 3 | 4 |
| recency | 3 | 1 | 0 | 0 | 4 |
| claim | 3 | 1 | 1 | 2 | 7 |
| amount | 48000 | 6000 | 2310 | 12000 | 39000 |
| MCCI_tag | 0 | 0 | 0 | 0 | 0 |
| MCCI_BE69_tag | 0 | 0 | 0 | 0 | 0 |
| MCCI_BE70_tag | 0 | 0 | 0 | 0 | 0 |
| MCCL_BE71 tag | 0 | 0 | 0 | 0 | 0 |
| MCCI_BE72_tag | 0 | 0 | 0 | 0 | 0 |
| BT20_tag | 0 | 0 | 1 | 0 | 0 |
| basic_policy | 3 | 3 | 5 | 2 | 1 |
| rider_policy | 3 | 1 | 3 | 0 | 1 |
| basic_premium | 80068 | 1562383 | 1558220 | 502630 | 2853 |
| rider_premium | 676 | 4800 | 113501 | 0 | 4800 |
| monthly_policy | 2 | 2 | 5 | 2 | 1 |
| annually_policy | 1 | 1 | 0 | 0 | 0 |
| semiannually_policy | 0 | 0 | 0 | 0 | 0 |
| quarterly_policy | 0 | 0 | 0 | 0 | 0 |
| direct_debit_policy | 2 | 0 | 1 | 0 | 1 |
| cash_policy | 0 | 2 | 0 | 1 | 0 |
| credit_card_policy | 1 | 0 | 4 | 1 | 0 |
| saving_policy | 2 | 2 | 0 | 2 | 1 |
| tranche_policy | 0 | 1 | 1 | 0 | 0 |
| whole_life_policy | 0 | 0 | 1 | 0 | 0 |
| decreasing_term_policy | 0 | 0 | 0 | 0 | 0 |
| legacy_policy | 0 | 0 | 1 | 0 | 0 |
| BE07_policy | 0 | 0 | 0 | 1 | 0 |
| BE21_policy | 0 | 0 | 0 | 0 | 0 |
| BE35_policy | 0 | 0 | 1 | 0 | 0 |
| BE36_policy | 0 | 0 | 0 | 0 | 0 |
| BE17_policy | 1 | 0 | 0 | 0 | |
| minor_claim | 3 | 1 | 1 | 2 | 7 |
| minor_amount | 48000 | 6000 | 2310 | 12000 | 39000 |
| direct_credit_claim | 0 | 0 | 1 | 0 | 7 |
| cheque_claim | 0 | 0 | 0 | 0 | 0 |
| direct_credit_amount | 0 | 0 | 2310 | 0 | 39000 |
| cheque_amount | 0 | 0 | 0 | 0 | 0 |
| lead_seller | 33 | 148 | 70 | 110 | 28 |
| tenure_seller | 6 | 10 | 8 | 8 | 8 |
| recency_seller | 0 | 0 | 0 | 0 | 0 |
| xsell_seller | 0.0303 | 0.0473 | 0.0571 | 0 | 0 |
| MCCI_seller | 0 | 0.0405 | 0 | 0 | 0 |
| saving_seller | 0.697 | 0.7703 | 0.5286 | 0.8909 | 0.9286 |
| health_seller | 0 | 0.0473 | 0.0143 | 0 | 0 |
| avg_basic_premium | 26689 | 520794 | 311644 | 251315 | 28533 |
| avg_range_basic_premium | (0-45k] | (300k+) | (300k+) | (80k-300k] | (0-45k] |

In a particular embodiment, the SPADE algorithm was applied to the dataset in Step 22 as is discussed in more detail below.

Next, at Step 30, data augmentation with partitioned training datasets was performed. Data augmentation techniques 32a, 32b, 32c, and 32d using in this case four different transformations further generalized the dataset 24 into four separate modified datasets 34a, 34b,34c, 34d.

In an exemplary embodiment, feature engineering was performed in Step 40, by conducting feature extraction on each a combined training set generated by combination of each of the augmented training sets. In a particular embodiment, Deep Feature extraction in Step 40 as detailed below was performed.

Three models were trained on each data set using Matthews Correlation Coefficient in the learning process of each model, as depicted by 52a, 52b, 52c. After the models were trained, in step 50 the Matthews Correlation Coefficient was also used in conjunction to weight the overall models used.

The outcome of the above processes when performed on the training dataset in an exemplary embodiment was a model characterised by the following performance parameters:

```
  ′colsample_bytree′: 0.5544936681788617,
  ′gamma′: 1.6404436728070604,
  ′learning_rate′: 0.009181568749236271,
  ′max_depth′: 4,
  ′min_child_weight′: 2.913626463742574,
  ′n_estimators′: 1515,
  ′reg_alpha′: 0.37970651492874785,
  ′reg_lambda′: 0.6072086607962488,
  ′subsample′: 0.9206789935908066
}
```

Similar results were obtained when used on an unknown data set, with the performance parameters as outlined.

Each of the above steps is now discussed in more detail below.

In the data augmentation Step 30, and as depicted in FIG. 1, four modified training data sets 34a, 34b, 34c, 34d are each augmented by a different data augmentation technique. It would be appreciated that alternative and/or additional algorithms and data augmentation techniques conducted in parallel could also be utilised to reduce overfitting when training the machine learning models on inherently imbalanced datasets which are generated from the original (imbalanced) data set. Data augmentation using different transformations assisted in preventing the model from learning irrelevant patterns, and was found to have minimized the impact from any processing and pre-processing methods, and provided a boost to overall performance.

Not using any one of exemplary augmentation processes was discovered to lead to an increased risk of skewing data and/or resulting in the model missing identification of potentially fraudulent cases and creating a problem that might not have otherwise been expected.

In an exemplary embodiment the data augmentation techniques applied in parallel are described below:

### (a) One-Hot Encoding Transformation

In one hot encoding each categorical value is converted into a new categorical column, and a binary value of 1 or 0 assigned to these columns.

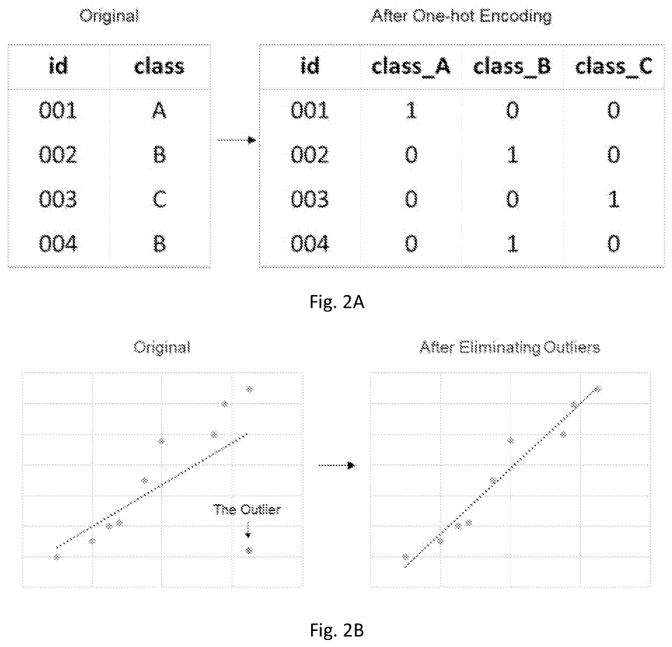

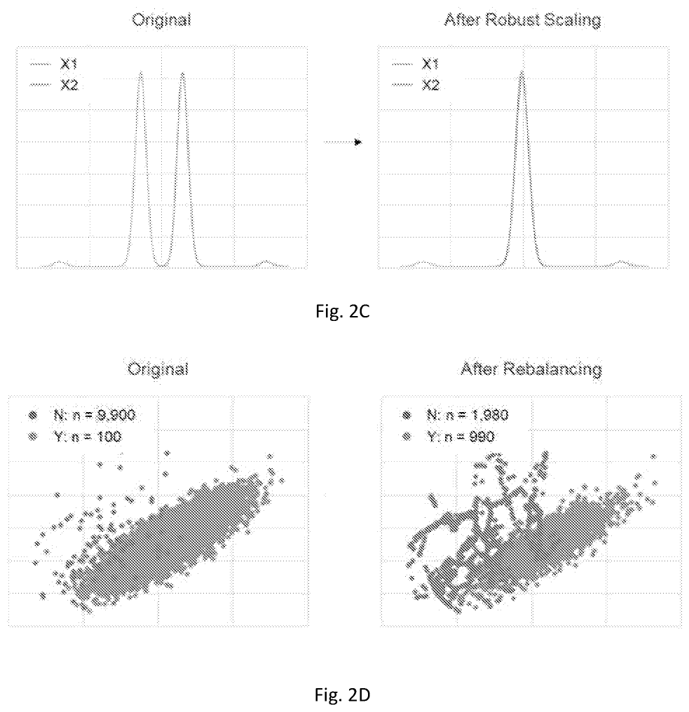

This means that integer values in the original data set can be represented as a binary vector; as is depicted in the exemplary FIG. 2A and represented as modified data set 34a.

### (b) Outlier Elimination

Persons skilled in the art appreciate outliers in data sets are inevitable, especially for large data sets, but such outliers create serious problems in statistical analyses, especially analyses using AI. It is essential to identify, verify, and accordingly trim outliers especially in a training data set to ensure that data interpretation and derived models are as accurate as possible.

In an embodiment, an unsupervised outlier detection algorithm (specifically the isolation forest algorithm), was used to identify unusual patterns/behaviour that didn't conform to the usual trend. It would be appreciated that the isolation forest outlier elimination technique is not distance based, but detects anomalies by randomly partitioning the domain space.

The isolation forest technique a tree ensemble method of decision trees which explicitly identifies anomalies instead of profiling normal data points. In the decision trees used, partitions are created by first randomly selecting a feature and then selecting a random split value between the minimum and maximum value of the selected feature.

It is this process that is used to generate one of the augmented data sets in FIG. 1, data set 34b.

In principle, outliers are less frequent than regular observations and are different from regular observations in terms of values (they lie further away from the regular observations in the feature space). That is why by using such random partitioning the outliers should be identified closer to the root of the tree (shorter average path length, i.e., the number of edges an observation must pass in the tree going from the root to the terminal node), with fewer splits necessary.

A schematic graphical representation of the data set resulting from an Outlier Elimination approach such as the isolation forest technique represented at a data level is depicted in FIG. 2B, showing a data set including an outlier and the modified data set after Outlier elimination.

### (c) Robust Standardization/Robust Data Scaling

It would be appreciated that outliers can often influence the sample mean/variance in a negative way. In such cases, scale features using statistics that are robust to outliers often give better results. It should be noted that “robust” does not mean immune, or completely unaffected. Instead, this approach does not “remove” outliers and extreme values (as with outlier elimination technique discussed above) but adjusts the data to minimise the impact of the outliers.

An example of robust data scaling is depicted in FIG. 2C, showing two independent variables before robust scaling and after robust scaling has been performed. Feature scaling to standardize range of independent variables so that they can be mapped onto same scale may also be used together with or at the same time as data scaling.

The robust data scaling approach is especially useful for machine learning algorithms using optimization algorithms such as gradient descent.

Centring and scaling are performed independently on each feature by computing the relevant statistics on the samples in the training set. Median and interquartile ranges are then stored to be used on later data using this transformation method and it is this process that is used to produce modified data set 34c.

### (d) Rebalancing Dataset

A problem with imbalanced classification arises if there are too few examples of the minority class for a model to effectively learn the decision boundary. In the present case it may be that in the data sample there are too many cases where there has not been any cross-selling activity, which distorts any model which is derived from such cases.

To address this imbalanced class distribution under-sampling and SMOTE techniques were combined in an embodiment of the present disclosure as a way of rebalancing the dataset.

This techniques in combination resulted in over-sampling the minority (cross-sell) class and under-sampling the majority (non-cross-sell) class of differently partitioned training data, producing the augmented data set 34d depicted in FIG. 1. SMOTE (Synthetic Minority Oversampling Technique) was introduced by Nitesh Chawla, et al. in 2002 named this technique titled “SMOTE: Synthetic Minority Over-sampling Technique.” SMOTE first selects the minority class instance at random and finds its k nearest minority class neighbours. The synthetic instance is then created by choosing one of the k nearest neighbours at random and connecting both to form a line segment in the feature space. The synthetic instances are generated as a convex combination of the two chosen instances.

As is known in the art, in SMOTE, the majority class is under-sampled by randomly removing samples from the majority class population until the minority class becomes some specified percentage of the majority class. This forces the learner to experience varying degrees of under-sampling and at higher degrees of under-sampling such that the minority class has a larger presence in the training set.

In an embodiment of the present disclosure, SMOTE was used to synthesize new examples from the minority class to have 10 percent the number of examples of the majority class, then random undersampling was used to reduce the number of examples in the majority class to have 50 percent more than the minority class.

By applying a combination of under-sampling and over-sampling, the initial bias towards the majority class is reversed in the favour of the minority class.

This is depicted schematically in FIG. 2D, where in 2D (i) the dataset has 9,900 members of the majority class N and 100 members of the minority class Y. Upon application of this combined technique; the synthesised new data set contains 1,980 members of the majority class N; and 990 members of the minority class Y; with associated values as depicted.

Before each data augmentation technique, before the data sets 34a, 34b, 34c and 34d were produced, the original data set 20 was processed using contextualised feature engineering; involving a sequential version of MBA (Market Basket Analysis). In an exemplary embodiment SPADE (Sequential Pattern Discovery using Equivalence classes) was used to introduce a time component to the analysis purchase intention of customers, in step 22. As is known in the art, using SPADE provided good interpretative information which can then be used for decision making at a business level in due course.

After data augmentation in step 34a,b,c, contextualized feature engineering could then be conducted in an exemplary embodiment using Deep Feature Synthesis Automated feature extraction was performed in step 40; resulting in modified datasets 44a, 44b, 44c, 44d.

Other types of sequential pattern mining algorithms could also be used such as generalised sequential pattern algorithms, however such algorithms are significantly slower than SPADE as they require significantly more computational resources.

A simplified example of the application of SPADE to the data set prior to augmentation is discussed below.
In the first pass sequences of length 1 were examined. Based on the most frequent single-length sequences (e.g. A appears more often than B), two types of two-element sequences were observed.
Two-element temporal sequences were observed (C→A means C to be purchased before A).
Two-element item groupings were observed (CD means C and D exist at a certain time simultaneously).
Then, based on the most frequent length-two outputs, three-element sequences (e.g. E→C→A) and three-element item groupings (e.g. BCE) were identified.
This process was continued until reaching the maximum length previously specified, or until reaching a length at which frequent outputs cannot be found.

SPADE outperforms most sequence mining approaches by a factor of two, minimizes I/O (Input/Output) costs by reducing database scans and also minimizes computational costs by using efficient search schemes. Advantageously, SPADE approach is also insensitive to data-skew.

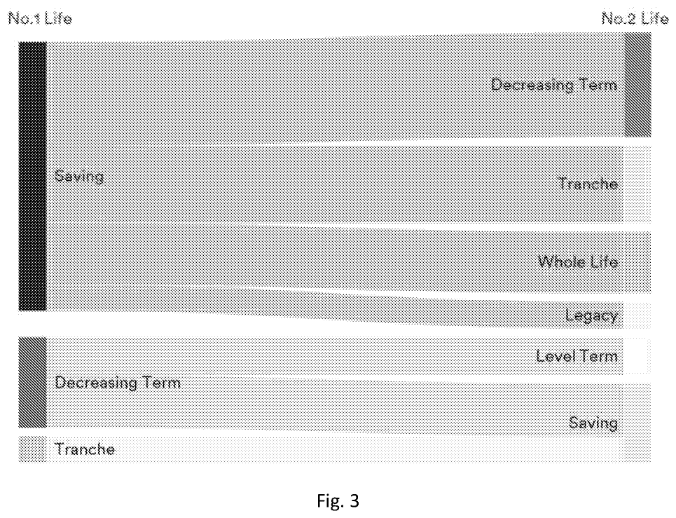

FIG. 3 depicts a visualisation made by using the Sequential Pattern Discovery Using Equivalence class (SPADE) algorithm of successive purchases of products made by 11,497 customers of various insurance products in the data set before data augmentation of the initial set.

In the first row; the type of first purchase is selected from the group comprising saving ( ) decreasing term and tranche. (Similarly the second purchase can be selected from between similar options, in this case decreasing term, tranche, whole life, legacy etc.).

As depicted, various pathways provide relative indications of the likely subsequent purchases made after various types of initial purchases. In the specifically highlighted sequence in FIG. 3, 9% of customers tend to cross-purchase whole life products after they bought saving products (path A) while 15% whole life products after buying a savings product within the defined timeframe.

Necessarily, it would be appreciated that with large databases such as 11,497 of customers who have acquired insurance products from a medium sized company, the search space would be extremely large.

For example, with m attributes there are O (m^{k}) potentially frequent sequences of length k. With millions of objects in the database the problem of I/O minimization becomes extremely important.

Using algorithms which are iterative in nature, it would be appreciated that as many full database scans as the longest frequent sequence would be required; which would be extremely computationally expensive. Furthermore, the use of complicated internal data structures required additional space and complexity to the determinations.

The high-level structure of SPADE algorithm is shown as follows:

SPADE(min_sup, D):

F₁={frequent items or 1-sequences};

F₂={frequent 2-sequences};

ε={equivalence classes [X]_{θ}_{₁}};

for all [X]∈εdo Enumerate-Frequent-Seq([X]);

Here min_sup is abbreviated variable for minimum support (the total number of sequences in database D that contains this sequence. an indication of how frequently the itemset appears in the dataset); a user-specified threshold. Where the minimum support threshold is 0.2; it would be appreciated that in 1 in 5 transactions recorded have this sequence.

The main steps of SPADE include:
(a) computation of the frequent 1-sequences and 2-sequences;
This step involves the determination of the frequency of appearance of each item in the sequence data (frequent 1-sequences e.g. determination of high number of purchases of critical illness); and the determination of frequency of frequent 2-sequences (for example: buy critical illness then buy saving products is a 2-sequence) in the sequence data.
(b) decomposition into prefix-based parent equivalences classes;
To obtain all the frequent sequences, it would be possible to enumerate and perform temporal joins. In practice, however, because of the limited amount of memory, the sequences are decomposed to classes; with each class having the same beginning item.
(c) enumeration of all other frequent sequences via Breadth-First Search (BFS) or Depth-First Search(DFS) by searching within each class.

While taking the customer's life stage and their own protection needs into account, another component that influences the customers' purchase intention in life insurance industries is discovered, that is, the correlation between the agent's performance and the customer's purchase intention. Customer retention feature importance is increased by considering the historical interactive records with their service agent or other service experiences.

It was identified that the behaviour of agents associated with the insurance company play a significant role in influencing the purchase intention of customers with whom they are interacting.

As is known in the art, tied agents are salespersons who sell policies for only one company, receives commissions for each policy sold and subsequent renewal/new policy from the same policyholder. In the present disclosure, any subsequent product recommendations arrive exclusively through the relevant tied agents of customers. Tied agents performance was identified as strongly influencing the purchase intention of customers with whom they are interacting.

With frequent 2 sequences approach used, the following key agent-related variables were identified for inclusion in the model:
1) cross-sold rate of agent (specified with a numerical value between 0-1)
2) agent with same product selling experience or not (boolean value)
3) agent tenure months (integer value)
4) agent activity (integer value)
5) multiple product categories the agent sold (boolean value)

Inclusion of the agent related features improve model predictive performance dramatically, as shown in Table 1 below.

TABLE 1
Performance comparison before and after adding agent-related features
(using XGBoost model on the same dataset with same parameters)

| evaluation | without agent-related | with agent-related | performance | |
|---|---|---|---|---|
| metrics | features | features | improved | |
| Accuracy | 0.962006 | 0.978563 | ↑ | 0.016557 |
| Precision | 0.849138 | 0.879741 | ↑ | 0.030603 |
| Specificity | 0.985113 | 0.986176 | ↑ | 0.001063 |
| Recall | 0.754067 | 0.910048 | ↑ | 0.155981 |
| F1 Score | 0.798784 | 0.894638 | ↑ | 0.095854 |
| ROC AUC | 0.984865 | 0.994464 | ↑ | 0.009599 |
| Cohen's Kappa | 0.777887 | 0.882709 | ↑ | 0.104821 |
| Matthews | 0.779559 | 0.882866 | ↑ | 0.103306 |
| Correlation | | | | |
| Coefficient | | | | |

Traditional feature selection for features extracted by rolling window aggregate calls for time-consuming iteration to generate features which can used by various models, and the decision of the period of rolling windows often relies on domain knowledge.

In view of the above performance with the additional agent features, a supermatic feature engineering algorithm with customized migration time window was also included. Use of this algorithm enable the auto-extraction features from multiple customer-related historical tables providing industry-specific relationships and depth of features.

In a further aspect, in an exemplary embodiment, DFS (Deep Feature Synthesis) algorithm was used to automate feature extraction with customized rolling window from multiple customer-related historical table in Step 40.

As is known in the art DFS (Deep Feature Synthesis) speeds up the process of building predictive models on multi-table datasets. In its mathematical function, relational aggregation features can be applied at two level, Entity Level and Relational Level.

Consider an entity for which features are synthesized:
Entity level features (EFEAT): Features calculated here are by considering the fields values in the table related to the entity alone.
Relational level: The features at this level are derived by in combination analysing entity(ies) related to a first entity. There are two possible categories of relationships between these two entities: forward and backward.
   Direct Features (DFEAT): Direct features can be applied over the forward relationships.
   Relational Features (RFEAT): Relational Features can be applied over backward relationships.

Apart from this, the training data for machine learning often come from different points in time or different period of time. To avoid leaking information, restriction time windows for each row of the resulting feature matrix is required. In an exemplary embodiment this was set to 3 months; although it would be appreciated that alternative time periods such as 6 month, 8 months, 12 months, 2 years etc. without limitation and subject to performance considerations.

In an embodiment of the invention, a further step of passing a data frame which includes index id and corresponding one or multiple rolling time periods. The rolling window limits the amount of past data that can be used while calculating a particular feature. Customer information will be excluded if the value of the time is either before or after the time window it performed.

In an embodiment using this data frame, the overall development time of feature extraction is 1 hour, which is 10 times less than typical manual processes for the same feature extraction—as conducted on a data set with 18040 records from which 56 features were extracted per record.

Advantageously this technique can stack primitives and be used in any relational database instead of artificial operations in different datasets.

In a further aspect, an ensemble of various optimized models using gradient boosting algorithms (e.g. XGboost, Catboost, LightGBM) was then created and trained in Step 52a,b,c; and stacked together in operation on each augmented data set 44a,44b, 44c, 44d in Step 50. Overall performance of each model was evaluated and weighted using the Matthews Correlation Coefficient as described below in Step 54.

Preferably these models are selected for execution speed and model performance in view of the large numbers of values in the data set.

As is known in the art, gradient boosting algorithms such as the above use a gradient boosting decision tree algorithm which creates new models to predict the residuals or errors of prior models and then added together to make the final prediction. A gradient descent algorithm is used to minimize the loss when adding new models. Each boosting technique and framework has a time and a place—and it is often not clear which will perform best until testing is conduct.

LightGBM is a gradient boosting algorithm which can construct trees using Gradient-Based One-Sided Sampling (GOSS). GOSS looks at the gradients of different cuts affecting a loss function and updates an underfit tree according to a selection of the largest gradients and randomly sampled small gradients. GOSS allows LightGBM to quickly find the most influential cuts.

XGBoost is a gradient boosting algorithm which uses the gradients of different cuts to select the next cut, but XGBoost also uses the hessian, or second derivative, in its ranking of cuts. Computing this next derivative comes at a slight processor cost.

CatBoost is a gradient boosting algorithm which instead focuses on optimizing decision trees for categorical variables (variables whose different values may have no relation with each other).

In an embodiment of the present disclosure LightGBM, CatBoost, and XGBoost were deployed as three weak base learners and stacked together.

An instance of each augmented dataset was evaluated by each of the respective gradient learning models in Step 50, and a weighted scoring based on each model output and associated MCC score was then derived in Step 54.

Advantageously, in Step 52a, 52b and 52c in training of each model, automatic hyperparameter learning using Sequential Model-Based Global Optimization (SMBO) was also utilised to optimise hyperparameters after the performance of the model was evaluated using the Matthews Correlation Coefficient.

As is known in the art, SMBO algorithm is a formalization of Bayesian optimization. The sequential aspect refers to running trials one after another, each time trying better hyperparameters by applying Bayesian reasoning and updating a probability model.

Five aspects of model-based hyperparameter optimization were used in accordance with this embodiment of the invention:
1. A domain of hyperparameters over which to search was specified;
2. An objective function that takes in hyperparameters and outputs a score was determined;
3. The surrogate model of the objective function was identified;
4. A criteria, or selection function, for evaluating which hyperparameters to choose next from the model
5. A history consisting of (score, hyperparameter) pairs used by the algorithm to update the mode.

By applying SMBO, the present disclosure is computationally more efficient in finding the best hyperparameters as compared with random or grid search. In an exemplary embodiment; based upon records from which 56 features were extracted above; performing a grid search took approximately 5 hours and 12 mins; whereas with SMBO on the same data set the time taken was approximately 1 hour 31 minutes.

Typical metrics used for evaluation of the performance in the model evaluation process, such as Accuracy, Sensitivity, Specificity, AUC (Area Under the ROC Curve), Recall, F1 Score, and Cohen's Kappa were not used in the preferred embodiment of the present disclosure. Unfortunately, these evaluation approaches do not perform well in both balanced and imbalanced situations as they sometimes they exhibit an undesired/incorrected behaviour. A confusion matrix, which allows visualization of the performance of a classifier, each column represents the cases in any predicted class, while each row represents the cases in any actual class.

Matthews Correlation Coefficient is more informative and reliable than these common measures in evaluating classification problems, especially F1 score and accuracy and other common rates in evaluating binary classification problems, because it takes into account the balance ratios of the four confusion matrix categories (true positives, true negatives, false positives, false negatives).

$$Matthews correlation coefficient ( M C C ) = \frac{T P \cdot T N - F P \cdot F N}{\sqrt{( T P + F P ) \cdot ( T P + F N ) \cdot ( T N + F P ) \cdot ( T N + F N )}}$$

$$( worst value = - 1 ; best value = + 1 ) .$$

As a reliable performance metric, especially for imbalanced datasets (in which the number of observations of one of the classes far exceed the quantity of the others), the MCC evaluates the agreement between the actual and the predicted classes by a classifier.

In an embodiment of the present disclosure, MCC was used both at the evaluation and training stage within each model (Step 52a, 52b, 52c) and also to weight in combination at Step 54 the output of the three models for each augmented data set.

Final output=(MCC of XGboost model*output of XGboost model)+(MCC of Catboost model*output of Catboost model)+(MCC score of LightGBM model*output of LightGBM model).

This final output was used an indicator of sorting priority which was used to devise a list of prioritised customer leads which can be contacted or followed up by call centre staff as appropriate.

In an embodiment, the number of iterations and random initialisation points were specified as 20 and 5 respectively; and it was noted that the performance and speed significantly outperformed other optimisation methods.

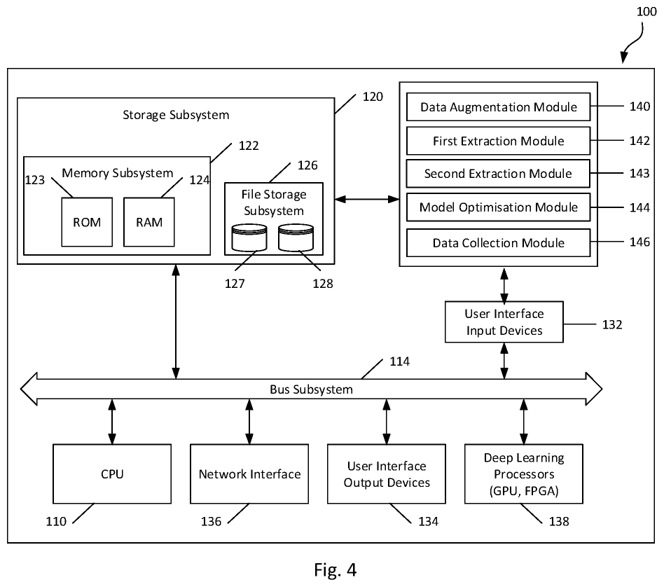

As depicted in FIG. 4, there is an exemplary computer system 100 in which the method of the present disclosure may be implemented. As depicted, the exemplary computer system may include computer executable instructions stored on non-transitory computer readable medium or media.

Computer system 100 typically includes at least one processor 110 that communicates with a number of peripheral devices via a data bus 114. These peripheral devices can include a storage subsystem 120 including, for example, memory subsystem 122 (including ROM 123 and RAM 124) and a file storage subsystem 126, user interface input devices 132, user interface output devices 134, and a network interface subsystem 136.

The input and output devices allow user interaction with computer system 100. Network interface subsystem 136 provides an interface to outside networks, including an interface to corresponding interface devices in other computer systems.

In one implementation, the plurality of data augmentation modules 140, feature extraction module(s) 142,143, model optimization module(s) 144, and data collection module(s) 146 communicably linked to the storage subsystem 120 and user interface input devices 132.

User interface input devices can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system.

User interface output devices 134 can include a display subsystem, a printer, a fax machine, or non-visual displays such as audio output devices. The display subsystem can include a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system to the user or to another machine or computer system.

Storage subsystem 120 stores programming and data constructs that provide the functionality of some or all of the modules and methods described herein. These software modules are generally executed by processor alone or in combination with other processors.

Memory used in the storage subsystem 120 can include a number of memories including a main random access memory (RAM) 124 for storage of instructions and data during program execution and a read only memory (ROM) 123 in which fixed instructions are stored.

A file storage subsystem 126 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 10 in the file storage subsystem 126, or in other machines accessible by the processor 110. Advantageously the training data set may be stored in a data storage facility such as a database or data store 127 while the trained model weights may be stored in the same or separate database or data store 128.

Bus subsystem 114 provides a mechanism for letting the various components and subsystems of computer system communicate with each other as intended. Although bus subsystem 114 is shown schematically as a single bus, alternative implementations of the bus subsystem 114 can use multiple busses.

Computer system itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system depicted in FIG. 4 is intended only as a specific example for purposes of illustrating the technology disclosed. Many other configurations of computer system are possible having more or less components than the computer system depicted in FIG. 4.

The deep learning processors can be GPUs or FPGAs 138 and can be hosted by a deep learning cloud platforms such as Google Cloud Platform, Xilinx, and Cirrascale. Examples of deep learning processors suitable for the present application include a standard Lenovo laptop with an i7 Processor and 32 GB of RAM.

The above embodiments are described by way of example only. Many variations are possible without departing from the scope of the disclosure as defined in the appended claims.

For clarity of explanation, in some instances the present technology may be presented as including individual functional blocks including functional blocks comprising devices, device components, steps or routines in a method embodied in software, or combinations of hardware and software.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, Universal Serial Bus (USB) devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer implemented method comprising
collecting data associated with a set of customers, and generating a data set therefrom containing data for customers having made two or more insurance purchases from one or more entities in a company group; said data including at least product type purchased, representative insurance agent information and timing of purchase;
extracting from the data set a first plurality of data fields using a sequential market basket analysis algorithm ;
generating a plurality of augmented training data sets using a plurality of different encoding techniques from said extracted first plurality of data fields;
extracting using an automatic feature extraction algorithm with a customised migration time window values for a second plurality of data fields from said plurality of augmented training data sets;
training in parallel a plurality of models on said second plurality of extracted data fields and evaluating the performance of each trained model thereupon;
weighting each trained model according to the determined model performance to provide an ensemble of trained models;
generating by said ensemble of trained models, a prediction of a propensity of a new customer of one or more products to purchase an additional product in a subsequent transaction upon receiving at least some values for said new customer including an initial product type purchased, customer status information, representative insurance agent information and timing of purchase.

2. The computer implemented method according to claim 1 wherein the customer status information comprises one or more values selected from the group comprising gender, marital status, location information, job level, age and policy account.

3. The computer implemented method according to claim 1 wherein the evaluation of the performance of each trained model on the second plurality of extracted data fields from said plurality of augmented data sets is evaluated using a Matthews Correlation Coefficient.

4. The computer implemented method according to claim 1 wherein the plurality of different encoding techniques are selected from the group comprising one hot encoding, outlier elimination, data scaling and rebalancing by oversampling minority class of cross sell product occurrence and undersampling the majority class of non-cross sell product.

5. The computer implemented method according to claim 4 wherein the undersampling of the majority class of non-cross sell product is performed by using the synthetic minority oversampling technique (SMOTE).

6. The computer implemented method according to claim 5 wherein undersampling was performed using the synthetic minority oversampling technique (SMOTE) to synthesize new examples for a minority class of cross sell occurrence such that the number of occurrences in the majority class of no cross sell occurrence had less than half the total of the sum of the number of occurrences in the majority class added to the number of occurrences in the minority class.

7. The computer implemented method according to claim 1 wherein the second plurality of data fields extracted from each augmented data set include a plurality of fields characterising the relationship between the customer and the insurance agent.

8. The computer implemented method according to claim 1 wherein the second plurality of data fields extracted from each augmented data set are selected from the group comprising cross selling score of the specified agent, product selling experience for the specified product, tenure of agent, agent activity and an indication of whether the agent has sold multiple product categories.

9. The computer implemented method according to claim 1 wherein the sequential market based analysis pattern extraction is performed using the Sequential Pattern Discovery using Equivalence classes (SPADE) algorithm.

10. The computer implemented method according to claim 1 wherein the overall weighting of each model in the prediction is determined by multiplying the Matthews Correlation Coefficient for each model by the output of that model.

11. A computer system for predicting the potential for cross selling an insurance product to a customer who has purchased an insurance product; the system comprising:
an ensemble of trained models which make a prediction of a propensity of a new customer of one or more products to purchase an additional product in a subsequent transaction upon receiving at least some values for said customer including an initial product type purchased, customer status information, representative insurance agent information and timing of purchase;
wherein said training of the ensemble of models is performed by a plurality of modules comprising:
a data collection module for receiving and storing a set of training data associated with a set of customers, and generating a dataset therefrom containing data for customers who have made two or more purchases from one or more entities in a company group; said data including at least product type purchased, representative insurance agent information and timing of purchase;
a first extraction module for extracting a first plurality of data fields using a sequential marked basket analysis algorithm from the dataset;
an augmentation module for generating a plurality of augmented training data sets using a plurality of different encoding techniques from the first plurality of data fields;
a second extraction module for extracting from each augmented dataset of training data a second plurality of data fields using an automatic feature extraction algorithm with a customised migration time window;
a model optimisation module for training in parallel a plurality of models on the second plurality of extracted data fields and evaluating the performance of each trained model; and weighting each trained model according to the determined model performance to provide said ensemble of trained models.

12. The computer system according to claim 11 wherein the customer status information comprises one or more values selected from the group comprising gender, marital status, location information, job level, age and policy account.

13. The computer system according to claim 11 wherein the evaluation of the performance of each trained model on the second plurality of extracted data fields from said plurality of augmented data sets is evaluated using a Matthews Correlation Coefficient.

14. The computer system according to claim 11 wherein the augmentation module is configured to apply a plurality of different encoding techniques to the training data set, wherein said encoding techniques are selected from the group comprising one hot encoding, outlier elimination, data scaling and rebalancing by oversampling minority class of cross sell product occurrence and under sampling the majority class of non-cross sell product.

15. The computer system according to claim 14 wherein the under sampling of the majority class of non-cross sell product is performed by using the synthetic minority oversampling technique (SMOTE).

16. The computer system according to claim 14 wherein under sampling was processed using the synthetic minority oversampling technique (SMOTE) to synthesize new examples for a minority class of cross sell occurrence such that the number of occurrences in the majority class of no cross sell occurrence had less than half the total of the sum of the number of occurrences in the majority class added to the number of occurrences in the minority class.

17. The computer system according to claim 11 wherein the first plurality of data fields extracted from each augmented data set include a plurality of fields characterising the relationship between the new customer and the insurance agent.

18. The computer system according to claim 17 wherein the plurality of data fields extracted from each augmented data set are selected from the group comprising cross selling score of the specified agent, product selling experience for the specified product, tenure of agent, agent activity and an indication of whether the agent has sold multiple product categories.

19. The computer system according to claim 11 wherein the sequential market based analysis pattern extraction is performed using the Sequential Pattern Discovery using Equivalence classes (SPADE) algorithm.

20. The computer system according to claim 11 wherein the automated feature extraction is performed using deep feature synthesis to build predictive data sets by stacking data primitives.

21. The computer system according to claim 11 wherein the overall weighting of each model in the model optimisation module in determining the prediction is determined by multiplying the Matthews Correlation Coefficient for each model by the output of that model.

22. A non-transitory computer readable storage medium having computer readable instructions recorded therein to predict a propensity of a new customer of one or more insurance products to purchase an additional product in a subsequent transaction, the instructions when executed on a processor cause that processor to implement a method comprising:
collecting data associated with a set of customers, and generating a dataset therefrom containing data for customers having made two or more insurance purchases from one or more entities in a company group; said data including at least product type purchased, representative insurance agent information and timing of purchase;
extracting from the dataset a first plurality of data fields using a sequential marked basket analysis algorithm;
generating a plurality of augmented training data sets using a plurality of different encoding techniques from said extracted first plurality of data fields;
extracting using an automatic feature extraction algorithm with a customised migration time window a second plurality of data fields from said plurality of augmented training data sets;
training in parallel a plurality of models on the second plurality of extracted data fields and evaluating the performance of each trained model thereupon;
weighting each trained model according to the determined model performance to provide an ensemble of trained models;
generating by said ensemble of trained models, a prediction of a propensity of a new customer of one or more products to purchase an additional product in a subsequent transaction upon receiving at least some values for said new customer including an initial product type purchased, customer status information, representative insurance agent information and timing of purchase.
